(19) United States
(12) Patent Application Publication
(10) Pub. No.: US 2024/0063511 A1
(43) Pub. Date: Feb. 22, 2024

(54) TRACTION BATTERY PACK BUSBAR SUPPORTING ASSEMBLY AND SUPPORTING METHOD

(71) Applicant: Ford Global Technologies, LLC, Dearborn, MI (US)

(72) Inventors: Ira Jason Goldberg, Ann Arbor, MI (US); Michael Barr, Canton, MI (US); Nicholas Braeseker, Novi, MI (US)

(21) Appl. No.: 17/890,562

(22) Filed: Aug. 18, 2022

(51) Int. Cl. H01M 50/507; H01M 50/211; H01M 10/658; H01M 50/262; H01M 10/613

(52) U.S. Cl. CPC H01M 50/507; H01M 50/211; H01M 10/658; H01M 50/262; H01M 10/613; H01M 2220/20

(57) ABSTRACT

A battery pack system includes first and second battery arrays of a traction battery pack, and a thermal barrier assembly disposed at least partially between the first and second battery arrays. The thermal barrier assembly is configured to block thermal energy movement from the first battery array to the second battery array, and from the second battery array to the first battery array. The system further includes a busbar interfacing directly with a portion of the thermal barrier assembly.

### TECHNICAL FIELD

This disclosure relates generally to thermal barrier of a traction battery pack and to supporting components of the traction battery pack using the thermal barriers.

### BACKGROUND

Electrified vehicles differ from conventional motor vehicles because electrified vehicles include a drivetrain having one or more electric machines. The electric machines can drive the electrified vehicles instead of, or in addition to, an internal combustion engine. A traction battery pack assembly can power the electric machines. The traction battery pack assembly of an electrified vehicle can include groups of battery cells arranged in arrays.

### SUMMARY

In some aspects, the techniques described herein relate to a battery pack system, including: first and second battery arrays of a traction battery pack; a thermal barrier assembly disposed at least partially between the first and second battery arrays, the thermal barrier assembly configured to block thermal energy movement from the first battery array to the second battery array, and from the second battery array to the first battery array; and a busbar interfacing directly with a portion of the thermal barrier assembly.

In some aspects, the techniques described herein relate to a system, wherein the busbar electrically couples together the first and second battery arrays.

In some aspects, the techniques described herein relate to a system, further including a cross-member disposed between the first and second battery arrays, the thermal barrier assembly secured directly to the cross-member.

In some aspects, the techniques described herein relate to a system, further including a plurality of mechanical fasteners that secure the cross-member directly to cross-member.

In some aspects, the techniques described herein relate to a system, wherein the thermal barrier assembly retains both the first and second battery arrays.

In some aspects, the techniques described herein relate to a system, wherein at least a portion of both the first and second battery arrays are sandwiched between the thermal barrier assembly and a surface of a battery pack enclosure.

In some aspects, the techniques described herein relate to a system, wherein the first and second battery arrays each include a plurality of battery cells disposed along a respective battery array axis, wherein a longitudinal axis of the thermal barrier assembly is parallel to the battery array axis of the first array and parallel to the battery array axis of the second array.

In some aspects, the techniques described herein relate to a system, further including a platform of the thermal barrier assembly, the busbar disposed on the platform.

In some aspects, the techniques described herein relate to a system, wherein the platform interfaces with an underside surface of the busbar, and further including a first ridge extending upward from a first side of the platform, and a second ridge extending upward from an opposite, second side of the platform, the first and second ridges interfacing with opposing laterally outer edges of the busbar that are oriented perpendicular to the underside surface.

In some aspects, the techniques described herein relate to a system, wherein the platform is part of a channel that receives the busbar.

In some aspects, the techniques described herein relate to a system, further including a busbar cap, at least a portion of the busbar sandwiched between the busbar cap and the platform.

In some aspects, the techniques described herein relate to a system, wherein a busbar cap and the thermal barrier together provide a component retention assembly.

In some aspects, the techniques described herein relate to a system, further including a coolant hose held by a component retention assembly.

In some aspects, the techniques described herein relate to a system, wherein the thermal barrier assembly is a polymer-based material.

In some aspects, the techniques described herein relate to a battery pack busbar supporting method, including: positioning a thermal barrier assembly between first and second arrays of a traction battery pack; electrically coupling the first and second arrays using at least one busbar; and holding the busbar with the thermal barrier assembly.

In some aspects, the techniques described herein relate to a method, further including holding the busbar within a channel of the thermal barrier assembly.

In some aspects, the techniques described herein relate to a method, further including holding a coolant hose with the thermal barrier assembly.

In some aspects, the techniques described herein relate to a method, further including attaching the thermal barrier assembly to a cross-member of the traction battery pack.

In some aspects, the techniques described herein relate to a method, further including retaining the first and second arrays with the thermal barrier assembly.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an example electrified vehicle have a traction battery pack.

FIG. 2 illustrates an expanded perspective view of selected portions of the traction battery pack of FIG. 1.

FIG. 3 illustrates a perspective view of a thermal barrier assembly and cross-member from the traction battery pack of FIG. 2.

FIG. 4 illustrates a section view taken at line 4-4 in FIG. 3.

FIG. 5 illustrates a close-up expanded view of an end of the thermal barrier assembly, busbar, and busbar cover from the traction battery pack of FIG. 2.

FIG. 6 illustrates a perspective view of an underside of the busbar and the busbar cover of FIG. 5.

FIG. 7 illustrates a close-up view of an end of the thermal barrier assembly, busbar, and busbar cover of FIG. 5.

FIG. 8 illustrates a close-up view of the end of the thermal barrier assembly and busbar of FIG. 8 but with another example busbar cover.

### DETAILED DESCRIPTION

This disclosure details thermal barrier assemblies used within a traction battery pack. The thermal barrier assemblies help to align and support busbars and other components.

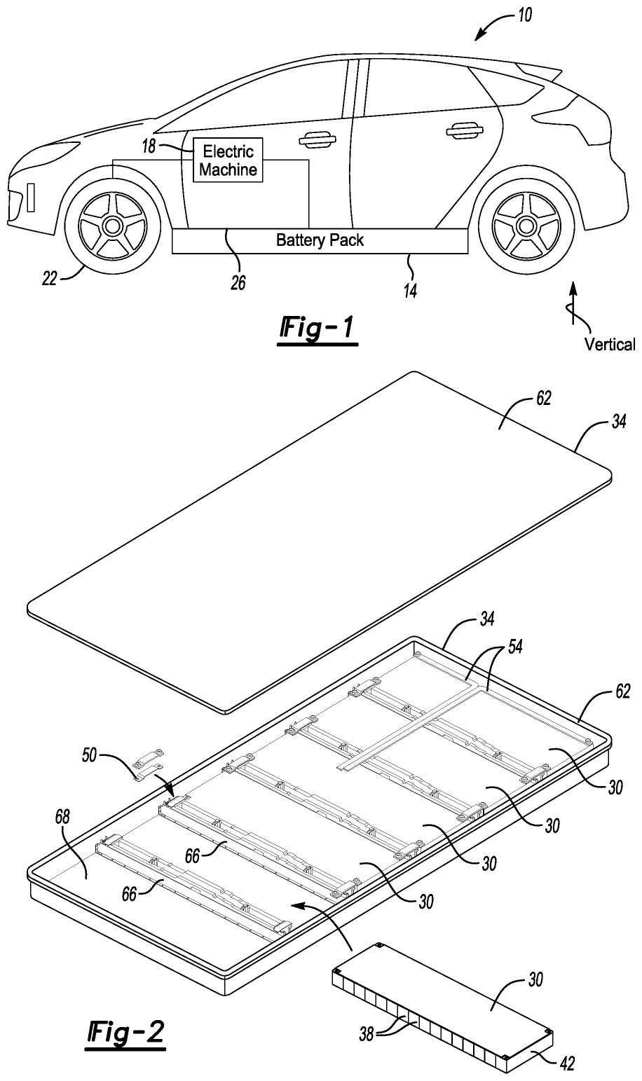

With reference to FIG. 1, an electrified vehicle 10 includes a traction battery pack 14, an electric machine 18, and wheels 22. The battery pack 14 powers an electric machine 18, which converts electric power to torque to drive the wheels 22. The battery pack 14 can be a relatively high-voltage battery.

The battery pack 14 is, in the exemplary embodiment, secured to an underbody 26 of the electrified vehicle 10. The battery pack 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead, or in addition to, an electric machine. Generally, the electrified vehicle 10 could be any type of vehicle having a traction battery pack.

Referring now to FIG. 2 with continuing reference to FIG. 1, the battery pack 14 includes a plurality of battery arrays 30 housed in an enclosure 34. The battery arrays 30 are groups of individual battery cells 38 arranged in a rows. In an embodiment, the battery cells 38 are lithium-ion pouch cells. However, battery cells having other geometries (cylindrical, prismatic, etc.), other chemistries (nickel-metal hydride, lead-acid, etc.), or both could alternatively be utilized within the scope of this disclosure.

In this example, the battery cells 38 of the arrays 30 are disposed along a respective axis of the battery array 30 and are compressed between the endplates 42. The arrays 30 each further include a top plate 46 that extends over the vertically upper surfaces of the battery cells 38. Vertical, for purposes of this disclosure is with reference to ground and a general orientation of the vehicle 10 during operation.

Various busbars 50 are incorporated into the battery pack 14. The busbars 50 electrically connect one of the arrays 30 to another of the arrays 30. The battery pack 14 can include other busbars 54 that electrically connect one or more of the arrays 30 to a device other than an array 30, such as a device that electrically couples the battery pack 14 to another part of the electrified vehicle 10 such as array to header vehicle connectors, front/rear motors and inverters, fast chargers, etc. The teachings of this disclosure are described in connection with the busbars 50, but could instead or additionally be applied to the busbars 54.

The enclosure 34 includes a tray 58 and a cover 62. The tray 58 can be stamped from a sheet metal blank, formed from extrusions, or formed from castings in some examples.

A plurality of cross-members 66 are positioned within the tray 58. The cross-members 66 can be secured to a floor 68 of the tray 58 using welds, mechanical fasteners, or adhesive materials. One of the cross-members 66 is disposed between each of arrays 30 in this example. The cross-members 66 extend in a cross-vehicle direction. The longitudinal axis of the cross-members 66 is, in this example, parallel to the axes of the battery arrays 30 within the battery pack 14. The cross-members 66 can strengthen the battery pack 14.

Atop at least some of the cross-members 66 are thermal barrier assemblies 70. Together with the cross-members 66, the thermal barrier assemblies 70 divide an interior of the battery pack 14 into various compartments. Each compartment houses one of the battery arrays 30. Should, for example, a thermal event occur in one of the battery arrays 30, the thermal barrier assemblies 70 can help to block thermal energy associated with the thermal event from moving to other battery arrays 30 and thereby inhibit a thermal runaway event.

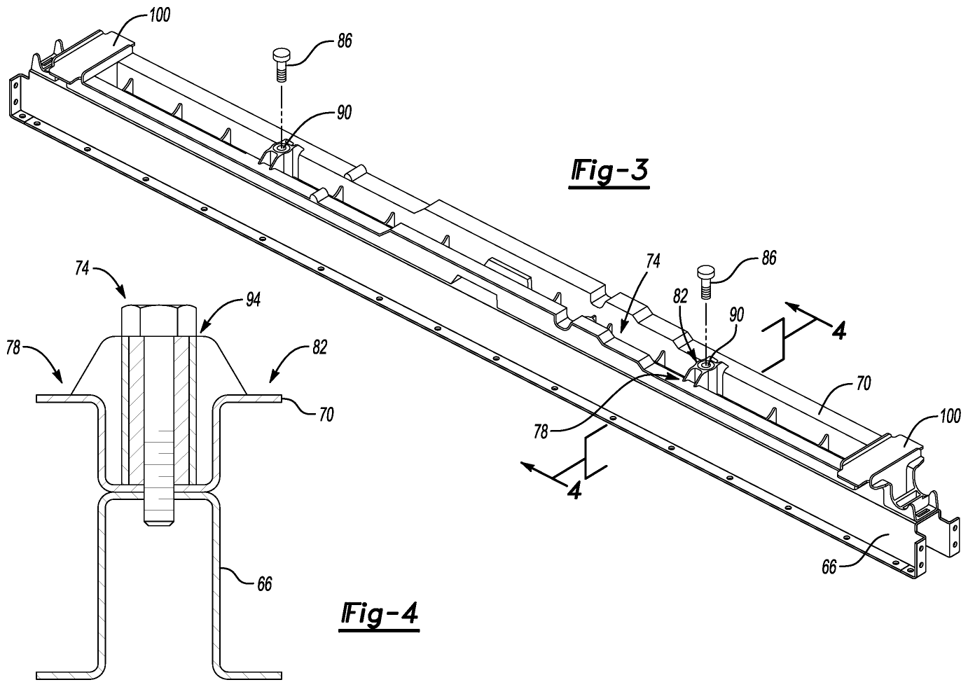

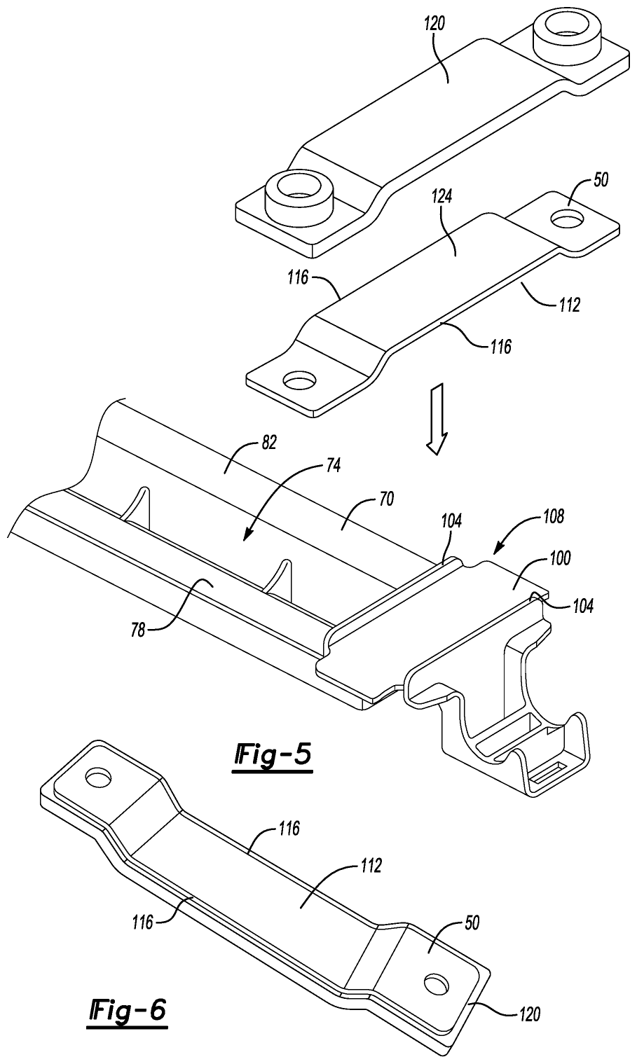

With reference now to FIGS. 3-7 and continued reference to FIG. 2, the thermal barrier assemblies 70 each include a primary attachment portion 74, a first lip 78, and a second lip 82. When installed, the primary attachment portion 74 interfaces directly with, and attaches directly to, one of the cross-members 66. The first lip 78 and the second lip 82 extend upward and outward from the primary attachment portion 74. When installed, the first lip 78 extends along a vertically upper side of one of the arrays 30 on a first side of the thermal barrier assembly 70, and the second lip 82 extends along a vertically upper side of another of the arrays 30 that is on a second side of the thermal barrier assembly 70.

The thermal barrier assembly 70 each attach to a respective cross-member 66 via at least one mechanical fastener 86. Securing the fasteners 86 draws the first lip 78 and the second lip 82 downward to sandwich the arrays 30 against the floor 68, which helps to secure and retain the respective arrays 30 within the enclosure 34. Each of the fasteners 86 can extend through a bore 90 in the primary attachment portion 74 to threadably engage the cross-member 66.

In some examples the fasteners 86 can additionally extend through a bore in the cover 62. The fasteners 86 then secure the cover 62 and the thermal barrier assemblies 70 to the cross-member 66 and separate fasteners to attach the thermal barrier assemblies 70 are not required.

In addition to blocking movement of thermal energy between the arrays 30, the thermal barrier assemblies 70 additionally help to align and support the busbars 50 while additionally providing a thermal barrier for the busbars 50. Utilizing the thermal barrier assemblies 70 in this way means that additional components are not needed to provide these functions. This can reduce an overall complexity of the battery pack 14.

The thermal barrier assemblies 70 are polymer-based structure in this example. The thermal barrier assemblies 70 can each be molded as a singular piece.

To interface with the busbars 50, the thermal barrier assemblies 70 includes at least one platform 100. First and second ridges 104 extend upward from respective first and second sides of the platform 100. The platform 100 and the ridges 104 provide a channel 108 that receives the busbars 50 and helps to align the busbars 50 in an installed position.

When one of the busbars 50 is received within the channel 108, the platform 100 interfaces directly with an underside surface 112 of the busbars 50, and the ridges 104 interface directly with the laterally outer edges 116 of the busbars 50. The laterally outer edges 116 are oriented perpendicular to the underside surface 112. The thermal barrier assemblies 70 provide a thermal barrier for these areas of the busbars 50.

A busbar cap 120 is separate from the thermal barrier assemblies 70 and the busbars 50. The busbar cap 120 can be a polymer-based material. The busbar cap 120 can be used to cover an upwardly facing surface 124 of one of the busbars 50 and can provide a thermal barrier. When the busbar cap 120 and the respective busbar 50 are secured in an installed position, the busbar 50 is sandwiched between one of the platforms 100 and the busbar cap 120. Mechanical fasteners (not shown) can extend through apertures 128 in the busbar 50 and busbar cap 120 to secure the busbar 50 and electrically couple the busbar 50 to the arrays 30.

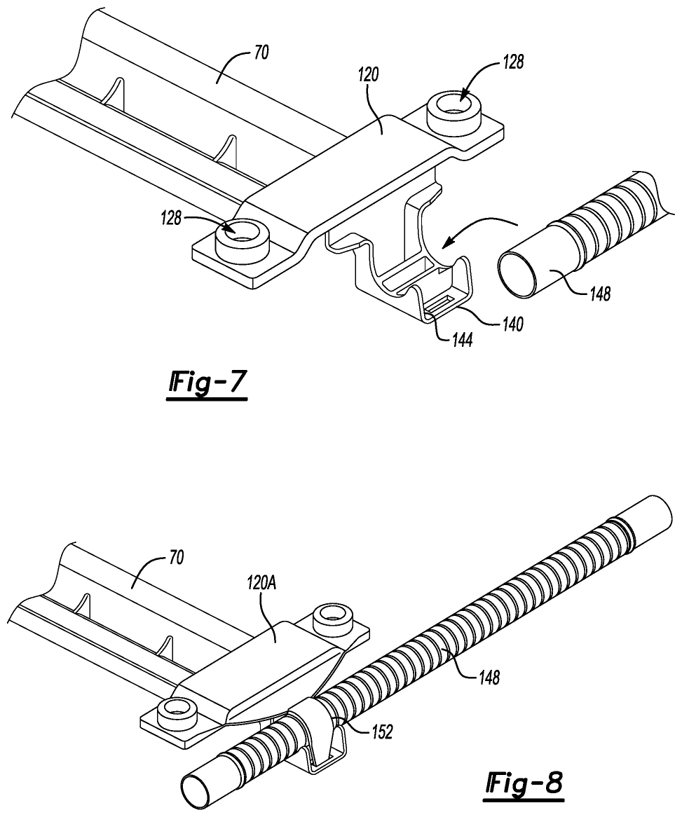

In this example, the thermal barrier assembly 70 provides, at each axial end, a component retention assembly 140. As shown in FIG. 7, the component retention assembly 140 includes a hook 144. A coolant hose 148 is held by the component retention assembly 140. In other examples, the component retention assembly 140 holds a wire harness, a sensor, a connector strain relief, another busbar, etc. Retention assemblies other than the hook 144 can be incorporated in other examples.

Referring to FIG. 8, in some examples, a busbar cover 120A can include a tab 152 that can engage the hook 144 to completely surround the coolant hose 148. This may provide more robust retention of the coolant hose 148 than placing the coolant hose 148 in the hook 144 without the tab 152.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A battery pack system, comprising:
first and second battery arrays of a traction battery pack;
a thermal barrier assembly disposed at least partially between the first and second battery arrays, the thermal barrier assembly configured to block thermal energy movement from the first battery array to the second battery array, and from the second battery array to the first battery array; and
a busbar interfacing directly with a portion of the thermal barrier assembly.

2. The system of claim 1, wherein the busbar electrically couples together the first and second battery arrays.

3. The system of claim 1, further comprising a cross-member disposed between the first and second battery arrays, the thermal barrier assembly secured directly to the cross-member.

4. The system of claim 3, further comprising a plurality of mechanical fasteners that secure the cross-member directly to cross-member.

5. The system of claim 1, wherein the thermal barrier assembly retains both the first and second battery arrays.

6. The system of claim 5, wherein at least a portion of both the first and second battery arrays are sandwiched between the thermal barrier assembly and a surface of a battery pack enclosure.

7. The system of claim 1, wherein the first and second battery arrays each include a plurality of battery cells disposed along a respective battery array axis, wherein a longitudinal axis of the thermal barrier assembly is parallel to the battery array axis of the first array and parallel to the battery array axis of the second array.

8. The system of claim 1, further comprising a platform of the thermal barrier assembly, the busbar disposed on the platform.

9. The system of claim 8, wherein the platform interfaces with an underside surface of the busbar, and further comprising a first ridge extending upward from a first side of the platform, and a second ridge extending upward from an opposite, second side of the platform, the first and second ridges interfacing with opposing laterally outer edges of the busbar that are oriented perpendicular to the underside surface.

10. The system of claim 8, wherein the platform is part of a channel that receives the busbar.

11. The system of claim 8, further comprising a busbar cap, at least a portion of the busbar sandwiched between the busbar cap and the platform.

12. The system of claim 1, wherein a busbar cap and the thermal barrier together provide a component retention assembly.

13. The system of claim 12, further comprising a coolant hose held by a component retention assembly.

14. The system of claim 1, wherein the thermal barrier assembly is a polymer-based material.

15. A battery pack busbar supporting method, comprising:
positioning a thermal barrier assembly between first and second arrays of a traction battery pack;
electrically coupling the first and second arrays using at least one busbar; and
holding the busbar with the thermal barrier assembly.

16. The method of claim 15, further comprising holding the busbar within a channel of the thermal barrier assembly.

17. The method of claim 15, further comprising holding a coolant hose with the thermal barrier assembly.

18. The method of claim 15, further comprising attaching the thermal barrier assembly to a cross-member of the traction battery pack.

19. The method of claim 15, further comprising retaining the first and second arrays with the thermal barrier assembly.
